(19) United States
(12) Patent Application Publication
(10) Pub. No.: US 2019/0180325 A1
(43) Pub. Date: Jun. 13, 2019

(54) SYSTEMS AND METHODS FOR INGESTING AND PROCESSING DATA IN A DATA PROCESSING ENVIRONMENT

(71) Applicant: Hispanispace, LLC, Burbank, CA (US)

(72) Inventors: Mario X. Carrasco, Burbank, CA (US); Roy E. KoKoyachuk, Burbank, CA (US)

(73) Assignee: Hispanispace, LLC, Burbank, CA (US)

(21) Appl. No.: 16/216,316

(22) Filed: Dec. 11, 2018

Related U.S. Application Data
(60) Provisional application No. 62/597,348, filed on Dec. 11, 2017.

(51) Int. Cl. G06Q 30/02; G06F 16/951

(52) U.S. Cl. CPC G06Q 30/0255; G06Q 30/0201; G06F 16/951

(57) ABSTRACT

Systems, methods, and articles of manufacture for ingesting and processing data in a data processing environment are disclosed. The system may receive data inputs from a plurality of data sources, including from surveys, panels, reports, behavioral monitoring applications, and the like. The system may parse and analyze the data inputs and store the data inputs in a data storage. The system may allow users to submit data analytic queries to retrieve the data inputs based on one or more data filters.

### CROSS-REFERENCE TO RELATED APPLICATIONS

This Non-Provisional patent application claims priority to U.S. Provisional Patent Application Ser. No. 62/597,348, entitled “SYSTEMS AND METHODS FOR INGESTING AND PROCESSING DATA IN A DATA PROCESSING ENVIRONMENT,” and filed Dec. 11, 2017, which is incorporated herein by reference in its entirety.

### FIELD

The disclosure generally relates to data processing, and more specifically, to systems and methods for ingesting and processing data in a data processing environment.

### BACKGROUND

Large data sets may exist in various sizes and organizational structures. With big data comprising data sets as large as ever, the volume of data collected incident to the increased popularity of online and electronic communications continues to grow. For example, billions of records (also referred to as rows) and hundreds of thousands of columns worth of data may populate a single table. Data processing environments may ingest data from hundreds of data sources with each data source transmitting hundreds of thousands of records.

Various entities, advertisers, or similar industries may desire to use big data sets regarding demographics to target particular population groups while advertising or designing products and services. For example, the parties may desire to analyze the big data sets to determine whether a particular population subset is more likely to purchase a particular product or service in comparison to other population subsets. Current data gathering and data analysis techniques focus on a binary approach wherein consumer interactions and usages are typically not considered, thus limiting the resulting data set, and the capabilities of targeting advertising and designing of products and services.

### SUMMARY

In various embodiments, systems, methods, and articles of manufacture (collectively, “the system”) for ingesting and processing data in a data processing environment are disclosed. The system may ingest data regarding demographics, consumer purchasing statistics, mobile data usage, or the like. The data may be transmitted to the data processing environment from various data sources, including surveys, reports, panels, mobile behavioral monitoring applications, and the like. The system may correlate and analyze the ingested data to provide an intelligent, robust, and holistic representative sample of various demographics. For example, the system may provide an interface to allow users to query the data storage and to request various analytics reports.

The system may comprise a processor and a tangible, non-transitory memory configured to communicate with the processor. The tangible, non-transitory memory may have instructions stored thereon that, in response to execution by the processor, cause the processor to perform operations. The operations may comprise: receiving, by the processor, data inputs from a plurality of data sources, wherein at least one of the data sources comprises a behavioral monitoring application; parsing, by the processor, the data inputs to determine data contained within each data input; and transmitting, by the processor, the data inputs to a data storage, wherein the data inputs are stored based on the parsed data contained within each data input.

In various embodiments, the system may further query the data storage to determine whether the data from the data inputs at least partially match stored data in the data storage. In response to determining that the data from the data inputs at least partially match stored data, the data input may be associated with the stored data prior to storing the data input. The system may also receive a data analytics query comprising a plurality of selected data filters; retrieve data inputs based on the selected data filters; and generate a data output comprising the retrieved data inputs.

In various embodiments, the behavioral monitoring application may be configured to monitor at least one of a user device or mobile applications installed on the user device. The behavioral monitoring application may be configured to return data inputs comprising at least one of user data, device information, network information, or mobile application data. The data sources may additionally comprise at least one of a data report, survey data, United States Census Bureau data, or a shopping loyalty program.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for ingesting and processing data from a plurality of data sources, in accordance with various embodiments;

FIG. 2 is a block diagram illustrating various sub-system components of a data processing environment for an exemplary system for ingesting and processing data from a plurality of data sources, in accordance with various embodiments;

FIG. 3 is a block diagram illustrating various components of a data source comprising behavioral monitoring of user devices, in accordance with various embodiments;

FIG. 4 illustrates a process flow for a method of ingesting data into a data processing environment, in accordance with various embodiments;

FIG. 5 illustrates a process flow for a method of monitoring usage on a user device, in accordance with various embodiments;

FIG. 6 illustrates a process flow for a method of processing a data analytics request in a data processing environment, in accordance with various embodiments;

FIG. 7A illustrates an exemplary data analytics screen layout of an exemplary data output interface, in accordance with various embodiments; and

FIG. 7B illustrates an exemplary data analytics screen layout of an exemplary data output interface, in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and/or functional changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments a system, method, and article of manufacture (collectively, “the system”) for ingesting and processing data in a data processing environment are disclosed. The system may ingest various types of data from one or more data sources. For example, the system may be configured to ingest data regarding demographics, such as age, gender, nationality, race, sexual orientation, education level, income level, marital status, occupation, religion, birth rate, death rate, average size of a family, average age at marriage, and/or the like. The system may also be configured to ingest data from surveys, reports, panels, or the like, such as for example, consumer likes or dislikes, consumer preferences, consumer spending habits, or the like. The system may also ingest data from a mobile monitoring application configured to transmit data regarding mobile phone usage (e.g., device properties and usage, mobile application properties and usage, etc.). The system may correlate and analyze the ingested data to provide an intelligent, robust, and holistic representative sample of various demographics. For example, the system may provide an interface to allow users to query the data storage and to request various analytics reports.

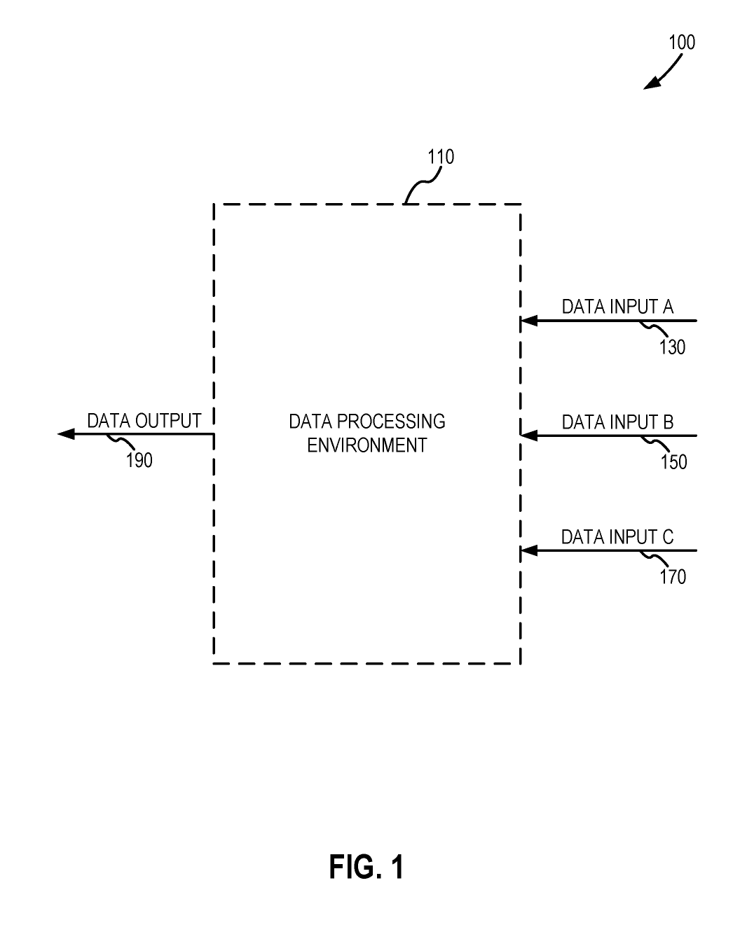

The system further improves the functioning of the computer or server (e.g., data processing environment 110, with brief reference to FIG. 1). For example, by automating the ingesting and analyzing of data inputs from various data sources, the system may partially increase the ability of the data processing environment to produce more accurate data aggregations, and may also partially increase the accuracy, consistency, and completeness of data outputs from the system. Furthermore, by automating the ingesting and analyzing of data inputs as opposed to needing the user to manually input and analyze the data inputs, the user performs less computer functions and provides less input, which saves on data storage and memory, thus speeding processing in the computer or server. Moreover, by partially reducing the need for user input, the speed of the ingesting and analyzing of data inputs may be increased. Additionally, by transmitting, storing, and accessing data using the processes described herein, the security of the data is improved, which decreases the risk of the computer or network, or the data itself from being compromised.

While the foregoing makes reference to demographic data and data analysis to be used in marketing and targeted advertising, it should be recognized by one skilled in the art that the present disclosure may extend to any suitable data processing system wherein ingesting and analyzing data may be desired.

In various embodiments, and with reference to FIG. 1, a system 100 for ingesting and processing data in a data processing environment is disclosed. System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. System 100 may also contemplate uses in association with web services, utility computing, pervasive and individualized computing, security and identity solutions, autonomic computing, cloud computing, commodity computing, mobility and wireless solutions, open source, grid computing and/or mesh computing.

In various embodiments, system 100 may comprise various systems, engines, modules, databases, and components with different roles. The various systems, engines, modules, databases and components described herein may be in direct logical communication with each other via a bus, network, and/or through any other suitable logical interconnection permitting communication amongst the various systems, engines, modules, databases and components, or may be individually connected as described further herein.

In various embodiments, system 100 may comprise a data processing environment 110. Data processing environment 110 may be configured to ingest data inputs (e.g., data input A 130, data input B 150, data input C 170, etc.), perform various operations on the data inputs, store the data inputs, and provide data outputs 190, as discussed further herein. Data processing environment 110 may be part of a big data environment and may be configured to receive hundreds of thousands of data records. As used herein, “big data” may refer to partially or fully structured, semi-structured, or unstructured data sets including millions of rows and hundreds of thousands of columns. A big data set may be compiled, for example, from data inputs (e.g., data input A 130, data input B 150, data input C 170, etc.) ingested into data processing environment 110 and/or from other suitable sources, as discussed further herein. In various embodiments, the big data sets may be compiled without descriptive metadata such as column types, counts, percentiles, or other interpretive-aid data points. In various embodiments, the big data sets may also be compiled and stored including metadata such as column types, counts, percentiles, or other interpretive-aid data points. As discussed further herein, the big data sets may be stored in various big-data storage formats containing millions of records (i.e., rows) and numerous variables (i.e., columns) for each record.

In various embodiments, data processing environment 110 may comprise any suitable system, module, environment, or the like. For example, data processing environment 110 may comprise a distributed file system. An exemplary distributed file system may comprise a distributed computing cluster configured for parallel processing and storage. Distributed computing cluster may be, for example, a Hadoop® cluster configured to process and store big data sets with some of the nodes comprising a distributed storage system and some of the nodes comprising a distributed processing system. In that regard, distributed computing cluster may be configured to support a Hadoop® distributed file system (HDFS) as specified by the Apache Software Foundation at http://hadoop.apache.org/docs/.

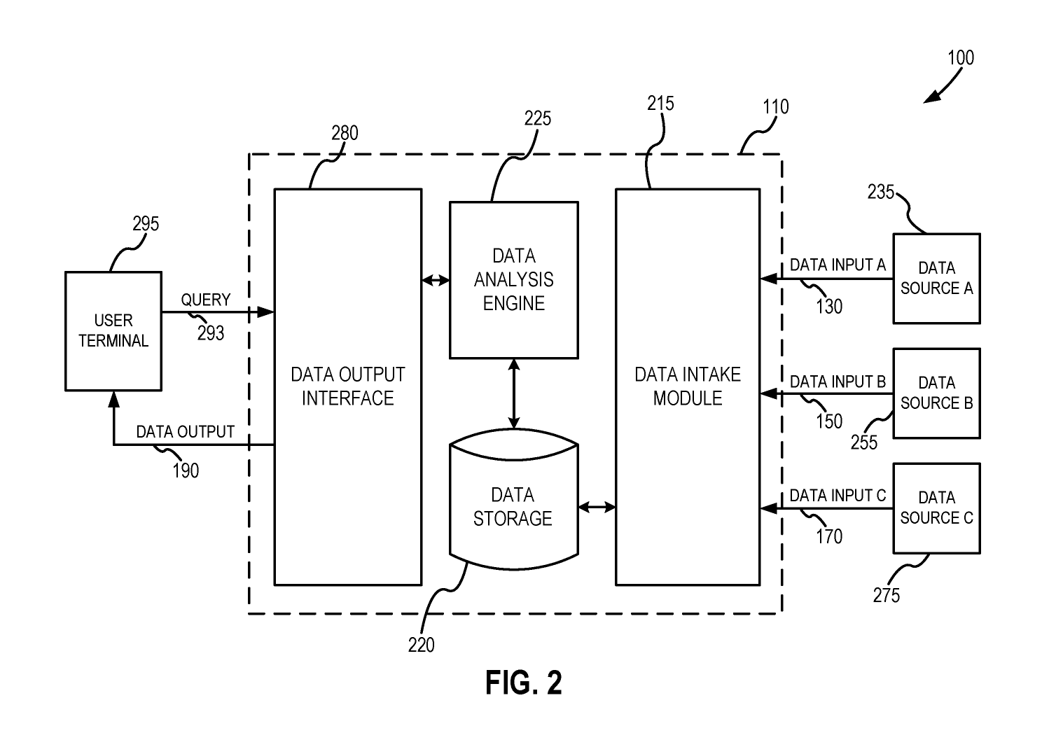

In various embodiments, data processing environment 110 may comprise one or more systems, components, modules, data structures, or the like configured to aide in the ingesting, transformation, parsing, and storing of data inputs. For example, and with reference to FIG. 2, data processing environment 110 may comprise one or more of a data intake module 215, a data storage 220, a data analysis engine 225, and/or a data output interface 280. Each module, database, engine, interface, or the like may comprise logical partitions of data processing environment 110, and/or may comprise independent and distinct hardware, processors, software, databases, or the like.

In various embodiments, data intake module 215 may be in electronic and/or operable communication with data storage 220. Data intake module 215 may be configured to ingest one or more data inputs from one or more data sources. For example, data intake module 215 may receive data input A 130 via a data source A 235, data input B 150 via a data source B 255, data input C 170 via data source C 275, and/or any other data inputs transmitted via any other suitable data source. Each data source 235, 255, 275 may comprise any suitable source of input data. For example, each data source may comprise a source of socioeconomic data, such as age, gender, sexual orientation, education level, income level, marital status, occupation, religion, birth rate, death rate, average size of a family, average age at marriage, and/or the like; purchasing data, such as consumer purchasing habits, consumer likes or dislikes, and/or the like; and/or similar such data. Each data source may also comprise a source of mobile phone usage (e.g., device properties and usage, mobile application properties and usage, etc.); consumer likes, dislikes, values, preference, and aspirations; consumer spending habits; and/or the like, as discussed further herein.

In various embodiments, each data source 235, 255, 275 may provide input data having varying data quality and accuracy. For example, an exemplary data source 235, 255, 275 may comprise censuses, surveys, reports, panels, administrative records, mobile tracking applications, or the like. In accordance with various embodiments, an exemplary data source 235, 255, 275 may comprise survey data. For example, surveys may be distributed online or via mail, email, telephone, or the like, or may be provided in-person, and completed by various individuals. Each survey may prompt an individual to answer one or more questions regarding the individual or the individual's household. For example, the surveys may prompt the individual to answer consumer preference questions (e.g., likes or dislikes), consumer usage or purchasing pattern questions, and or similar type questions. For example, each survey may address one or more topics of consumer preference such as automotive, consumer packaged goods, media, or the like. In various embodiments, an exemplary data source 235, 255, 275 may comprise panel data. Panel data may be gathered in response to a consumer registering for a survey, discussion panel, and/or the like. For example, panel data may comprise basic information and demographic data such as age, income, gender, region, etc.

In various embodiment, an exemplary data source 235, 255, 275 may comprise the United States Census Bureau, and the transmitted data input may comprise census data, including demographic data. Data source 235, 255, 275 may also comprise administrative records, and/or other similar state or government census records.

In various embodiments, an exemplary data source 235, 255, 275 may comprise shopping loyalty programs (e.g., credit card loyalty programs, grocery store loyalty programs, etc.), wherein a consumer is provided loyalty points, discounts, rewards, or the like in exchange for allowing the entity to track purchases, spending habits, and other such data.

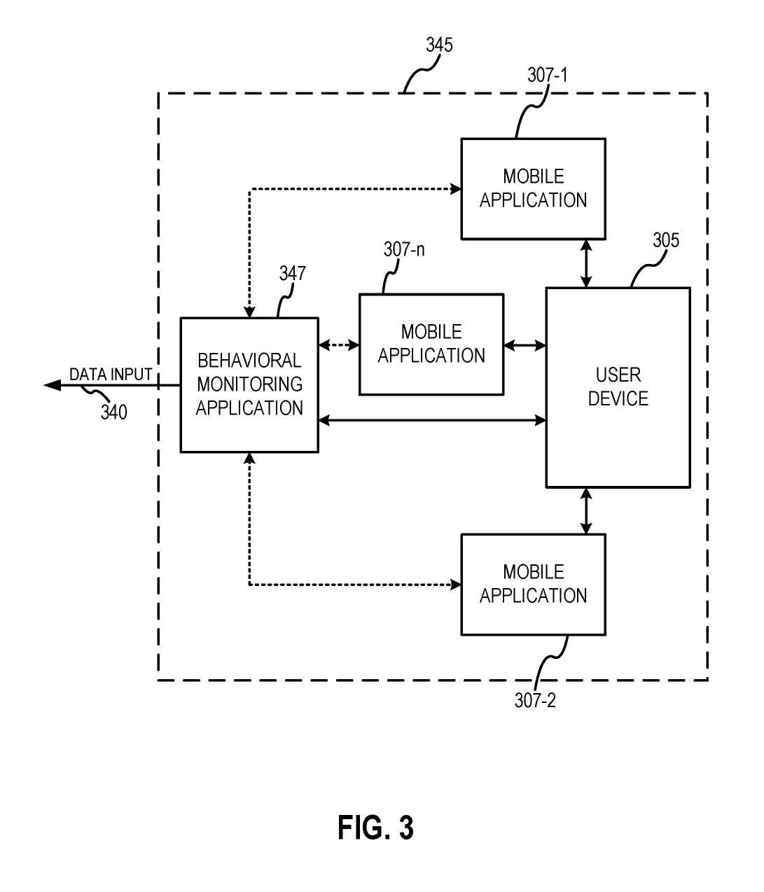

In various embodiments, and with reference to FIG. 3, an exemplary data source 345 comprising behavioral monitoring of user devices is depicted. Data source 345 may comprise a behavioral monitoring application 347 in electronic and/or operable communication with a user device 305 and one or more mobile applications (e.g., a first mobile application 307-1, a second mobile application 307-2, an “Nth” mobile application 307-n, etc.) installed on user device 305. User device 305 may comprise a personal computer, personal digital assistant, cellular phone, smartphone (e.g., IPHONE®, BLACKBERRY®, and/or the like), kiosk, and/or the like. User device 305 may comprise an operating system, such as, for example, a WINDOWS® mobile operating system, an ANDROID® operating system, APPLE® IOS®, a BLACKBERRY® operating system and the like. Each mobile application 307-1, 307-2, 307-n may comprise software and/or database components installed on user device 305. For example, each mobile application 307-1, 307-2, 307-n may comprise an application, micro-app, web page, or the like configured to leverage the resources of the larger operating system and associated hardware on user device 305, via a set of predetermined rules which govern the operations of various operating systems and hardware resources, as discussed further herein.

Behavioral monitoring application 347 may be configured to gather data regarding components in data source 345 and transmit the data as a data input 340 to data processing environment 110. In various embodiments, the gathered data may be configured to include a timestamp corresponding to the date and time the data was gathered. Behavioral monitoring application 347 may be configured to monitor user device 305 and mobile application 307-1, 307-2, 307-n to track properties and usage. In various embodiments, a user may register with behavioral monitoring application 347 prior to enabling behavioral monitoring application 347 to monitor user device 305 and mobile application 307-1, 307-2, 307-n. In that respect, behavioral monitoring application 347 may be configured to prompt the user, via user device 305, to input user data. The user data may comprise any suitable or desired data regarding the user, such as, for example, name (e.g., first name, last name, etc.), birthdate, gender, contact information (e.g., email address, telephone number, etc.), address information (e.g., street, city, state, zip code, etc.), persons in household, highest level of education, employment status, employment title, household income, ethnicity, and/or similar data. Behavioral monitoring application 347 may transmit the user data as a data input 340 to data intake module 215 in data processing environment 110, as discussed further herein.

In various embodiments, users may be given an incentive to register and use behavioral monitoring application 347. For example, users may be entered into a sweepstakes and/or provided monetary considerations in exchange for allowing behavioral monitoring application 347 to monitor user device 305 and mobile application 307-1, 307-2, 307-n.

In various embodiments, behavioral monitoring application 347 may be configured to monitor user device 305 to compile user device data, such as device information, network information, and the like. Device information may include data corresponding to user device 305, such as, for example, hardware details (e.g., make, model, CPU metrics, hardware specifics, registry, configuration, etc.), unique identifiers (e.g., international mobile equipment identity (IMEI) number, international mobile subscriber identity (IMSI) number, media access control (MAC) address, etc.), software details (e.g., operating system, anti-virus, programs, applications, etc.), settings (e.g., Wi-Fi settings, Bluetooth settings, airplane mode, screen timeout settings, display settings, security lock timeouts, etc.), battery state (e.g., battery level, battery type, battery temperature, battery voltage, etc.), charger/dock state, mobile profile (e.g., type, name, ring tone, message tone, vibrate settings, volume, warning and message alerts, etc.), security provisions (e.g., lock screen enabled, biometric login enabled, etc.), and/or the like. Network information may include data corresponding to the connectivity of user device 305, such as, for example, internet protocol (IP) address (e.g., host name, host address, local host address and state, etc.), Bluetooth connection (e.g., address, classes, name, paired/non-paired, etc.), USB connectivity, wireless local area network (WLAN) connectivity (e.g., service set identifier (SSID), basic service set identification (BSSID), connection mode, security mode, signal strength, name, etc.), cellular network information (e.g., MCC, MNC, LAC, CID, etc.), virtual private network (VPN) state (e.g., connection requests, time of request, process that initiated or terminated the request, etc.), wireless network traffic, known devices connected to the same wireless network, and/or the like. Behavioral monitoring application 347 may transmit the user device data as a data input 340 to data intake module 215 in data processing environment 110, as discussed further herein.

In various embodiments, behavioral monitoring application 347 may also be configured to monitor the mobile applications (e.g., mobile application 307-1, 307-2, 307-n) installed on user device 305 to compile mobile application data. Mobile application data may comprise any suitable data regarding mobile application usage, such as, for example, mobile application identity (e.g., name, version, updates, status, usage, foreground/background, URL's visited, etc.), music player (e.g., track, artist, duration, etc.), video player (e.g., video name, duration, etc.), browser traffic (e.g., URL's, address, usage, traffic, search strings, response/loading time, cookies, etc.), videos (e.g., audio codes, video codes, watermarks, signals, tags, etc.), ad campaign exposure, global positioning system (GPS) state (e.g., latitude, longitude, altitude, etc.), alarm usage (e.g., state, application, repeat condition, expiration time, etc.), social media usage (e.g., FACEBOOK®, TWITTER®, INSTAGRAM®, SNAPCHAT®, etc.), and/or the like. For example, and in accordance with various embodiments, ad campaign exposure and similar exposure measurements can be determined by using cookies, tags, pixels, or the like placed in the corresponding advertisement. Behavioral monitoring application 347 may be configured to identify the cookie, tag, pixel, etc., and track the user's interaction with the advertisement. For example, behavioral monitoring application 347 may track the number of users exposed to the advertisements together with specific user actions such as whether the advertisement was ignored, clicked on or otherwise interfaced with, and/or if a purchase or call to action was made. Behavioral monitoring application 347 may transmit the mobile application data as a data input 340 to data intake module 215 in data processing environment 110, as discussed further herein.

In various embodiments, and with reference again to FIG. 2, data intake module 215 may be configured to parse the received data inputs 130, 150, 170 to determine the data contained therein. For example, data intake module 215 may parse the data inputs 130, 150, 170 to determine the data fields (e.g., name, address, etc.) and corresponding data values (e.g., “John Smith,” “123 E. 1^{st} St.,” etc.) of the data contained within each data input 130, 150, 170.

Data intake module 215 may be configured to query data storage 220 to determine whether the parsed data inputs 130, 150, 170 partially match preexisting and stored data (e.g., a “name” from the parse data inputs 130, 150, 170 preexists in data storage 220). In various embodiments, data storage 220 may be configured as a central repository for storing data inputs. Data storage 220 may be in electronic and/or operable communication with data intake module 215 and/or data analysis engine 225. Data storage 220 may comprise any suitable combination of hardware, software, and/or database components. Data storage 220 may be configured to store and maintain the data in any suitable format and using any suitable technique.

In response to determining that the parsed data inputs 130, 150, 170 partially match preexisting and stored data in data storage 220, data intake module 215 may append metadata, tags, or otherwise associate the corresponding data input to indicate the location of the matching stored data. Data intake module 215 may transmit the parsed data inputs 130, 150, 170 for storage in data storage 220, and data storage 220 may store the parsed data input 130, 150, 170 to correspond to or reference the matching stored data. In response to determining that the parsed data inputs 130, 150, 170 do not partially match preexisting and stored data in data storage 220, data intake module 215 may transmit the parsed data inputs 130, 150, 170 for storage in data storage 220.

In various embodiments, data output interface 280 may be configured as a user interface to access and requests data analysis of data stored in data storage 220 in data processing environment 110. Data output interface 280 may in electronic and/or operable communication with data analysis engine 225 and/or a user terminal 295. User terminal 295 may comprise a personal computer (e.g. laptop, desktop, etc.), personal digital assistant, cellular phone, smartphone (e.g., IPHONE®, BLACKBERRY®, and/or the like), kiosk, and/or the like. User terminal 295 may comprise an operating system, such as, for example, a WINDOWS® mobile operating system, an ANDROID® operating system, APPLE® IOS®, a BLACKBERRY® operating system and the like. Practitioners will appreciate that user terminal 295 may or may not be in direct contact with data output interface 280. For example, user terminal 295 may access the services of data processing environment 110 through another server, which may have a direct or indirect connection to an internet server. Practitioners will further recognize that user terminal 295 may present interfaces associated with a software application or module that are provided to user terminal 295 via application graphical user interfaces (GUIs) or other interfaces and are not necessarily associated with or dependent upon internet browsers or internet specific protocols. In that regard, a user may interact with user terminal 295 to transmit and receive data, as discussed further herein.

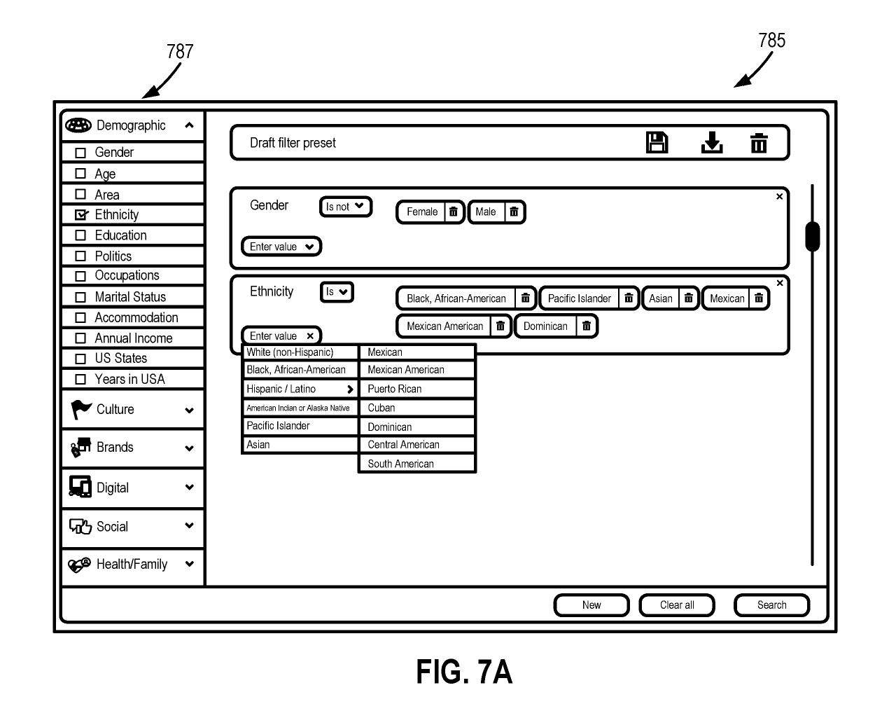

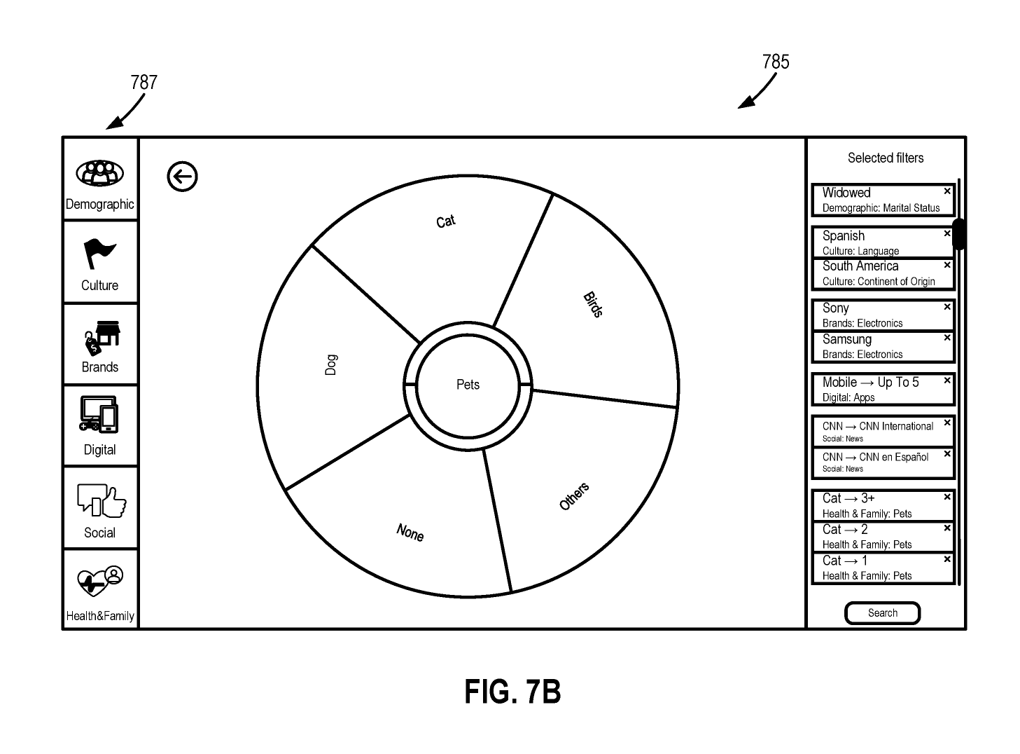

For example, users may interact with data output interface 280, via user terminal 295, to transmit a query 293 (e.g., a data analytics query) and to receive a corresponding data output 190. User terminal 295 and/or data output interface 280 may transmit and receive data using any suitable messaging platform, such as email systems, wireless communications systems, mobile communications systems, multimedia messaging service (MMS) systems, short messaging service (SMS) systems, and the like. For example, data output interface 280 may transmit and receive data by displaying query options and data via a GUI, webpage, or the like, for viewing by the user on user terminal 295. For example, and with brief reference to FIGS. 7A and 7B, an exemplary GUI 785 of an exemplary data output interface is depicted. GUI 785 may enable users, via user terminal 295, to select various data filters 787 to generate a query 293 to data output interface 280. For example, data filters 787 may comprise filters including demographic, culture, brands, digital, social, health and family, or the like. Users may select one or more data filter selections under each data filter 787 to complete the query 293.

With reference again to FIG. 2, in response to receiving a query 293 from user terminal 295, data output interface 280 may transmit the query 293 to data analysis engine 225. Data analysis engine 225 may be in electronic and/or operable communication with data storage 220 and/or data output interface 280. Data analysis engine 225 may be configured to receive the query 293 and parse the query 293 to determine the selected data filters or other attributes. Data analysis engine 225 may query data storage 220 to retrieve the stored data based on the parsed data filters in query 293. For example, wherein the query 293 comprises selected data filters of marital status=“widowed,” pets=“3+”, age=“20-30,” and/the like, data analysis engine 225 may query data storage 220 to retrieve all stored data records comprising data meeting those data filters. Data analysis engine 225 may generate a data output 190 comprising all of the retrieved data. Data analysis engine 225 may transmit the data output 190 to data output interface 280 for transmission or display to user terminal 295, as previously discussed. In that respect, a user, via user terminal 295 may view the data output 190 and may adjust the query 293 in real time to update the query (e.g., selecting/deselecting data filters, etc.) to revise the data output 190.

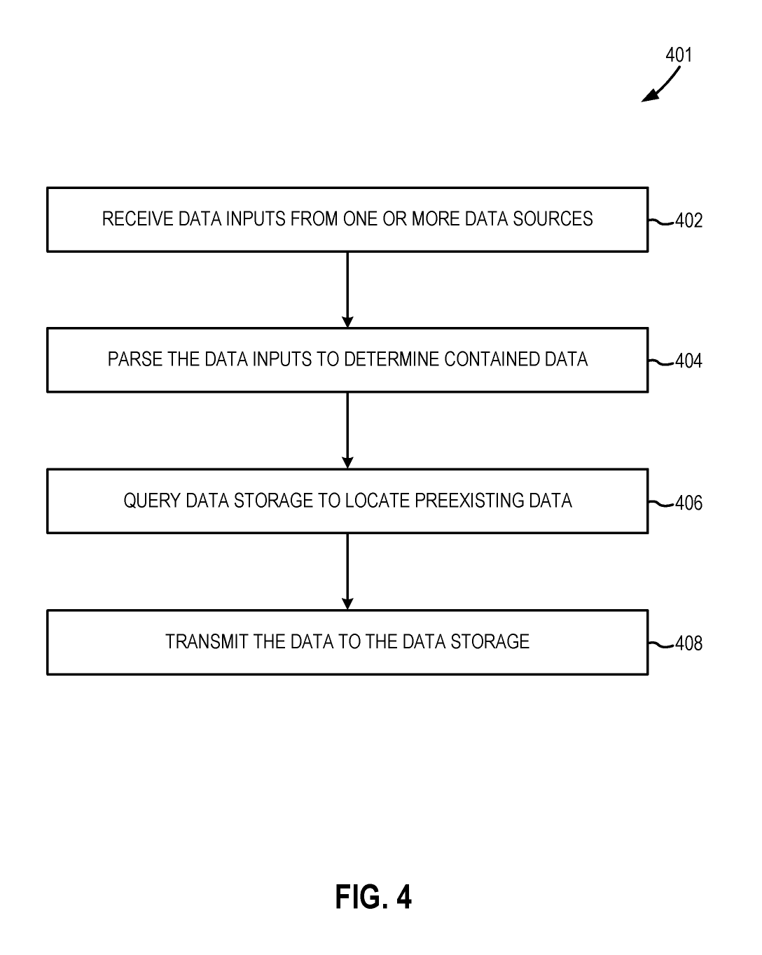

Referring now to FIGS. 4-6, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and elements depicted in FIGS. 4-6, but also to the various system components as described above with reference to FIGS. 1-3.

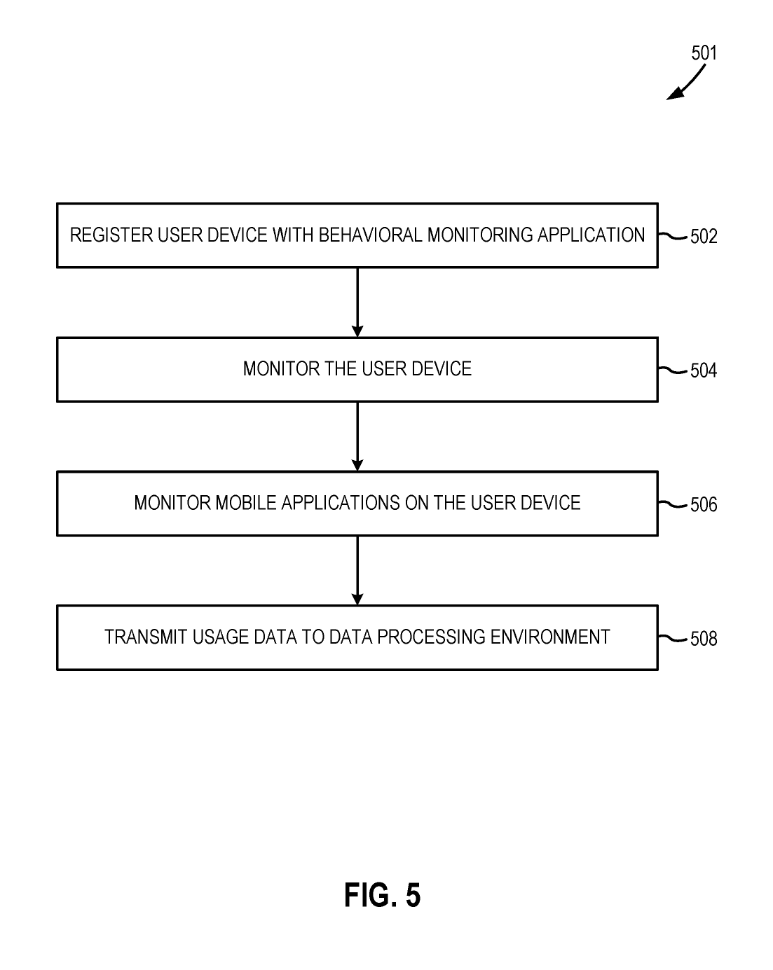

With reference to FIG. 4, a method 401 for ingesting data into a data processing environment is disclosed. Method 401 may comprise receiving data inputs from one or more data sources (step 402). Data intake module 215 may be configured to receive one or more data inputs from various data sources, such as a data input A 130 via a data source A 235, data input B 150 via a data source B 255, data input C 170 via data source C 275, and/or any other data inputs transmitted via any other suitable data source. Each data input may comprise any suitable source of data, such as, for example, censuses, surveys, administrative records, mobile tracking applications, or the like. As a further example, and with reference to FIG. 5, a method 501 for monitoring usage on a user device is disclosed. Method 501 may comprise registering a user device with a behavioral monitoring application (step 502). A user may register, via user device 305, with behavioral monitoring application 347 prior to enabling behavioral monitoring application 347 to monitor user device 305 and mobile application 307-1, 307-2, 307-n. In that respect, behavioral monitoring application 347 may be configured to prompt the user, via user device 305, to input various user data, as previously discussed.

Method 501 may comprise monitoring the user device (step 504). Behavioral monitoring application 347 may be configured to monitor user device 305 to compile user device data, such as device information, network information, and the like, as previously discussed. Method 501 may comprise monitoring mobile applications on the user device (step 506). Behavioral monitoring application 347 may also be configured to monitor the mobile applications (e.g., mobile application 307-1, 307-2, 307-n) installed on user device 305 to compile mobile application data, as previously discussed. In various embodiments, behavioral monitoring application 347 may monitor user device 305 and mobile applications 307-1, 307-2, 307-n simultaneously or near-simultaneously, and in real time or near real time. Method 501 may comprise transmitting usage data to the data processing environment (step 508). Behavioral monitoring application 347 may transmit the mobile application data as a data input 340 to data intake module 215 in data processing environment 110.

With reference again to FIG. 4, method 401 may comprise parsing the data inputs to determine contained data (step 404). Data intake module 215 may be configured to parse the received data inputs 130, 150, 170 to determine the data contained therein. Method 401 may comprise querying data storage to locate preexisting data (step 406). Data intake module 215 may be configured to query data storage 220 to determine whether the parsed data inputs 130, 150, 170 partially match preexisting and stored data (e.g., a “name” from the parse data inputs 130, 150, 170 preexists in data storage 220). In response to determining that the parsed data inputs 130, 150, 170 partially match preexisting and stored data in data storage 220, data intake module 215 may append metadata, tags, or otherwise associate the corresponding data input to indicate the location of the matching stored data in data storage 220. Method 401 may comprise transmitting the data to the data storage (step 408). Data intake module 215 may transmit the parsed data inputs 130, 150, 170 for storage in data storage 220. In response to data intake module 215 previously locating a partial match in data storage 220, data storage 220 may store the parsed data input 130, 150, 170 to correspond to, reference, or be grouped with the matching stored data.

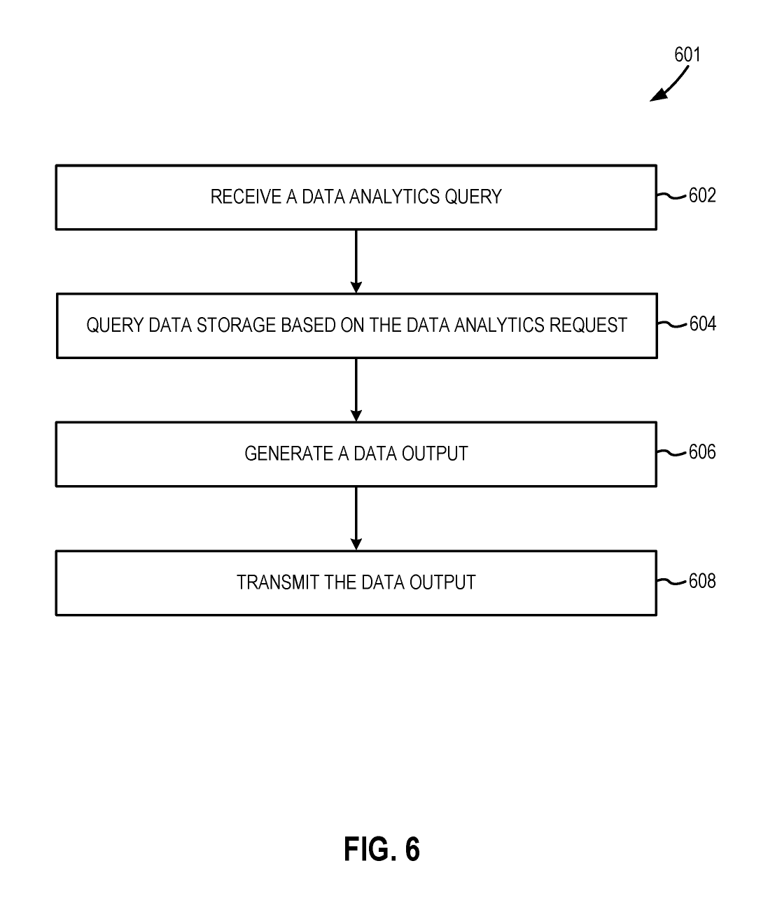

With reference to FIG. 6, a method 601 for processing a data analytics request in a data processing environment is disclosed. Method 601 may comprise receiving a data analytics request (step 602). Data output interface 280 may receive the data analytics request (e.g., query 293) from user terminal 295 in response to a user selecting or inputting one or more data filters. Data output interface 280 may transmit the data analytics request to data analysis engine 225. Method 601 may comprise querying the data storage based on the data analytics request (step 604). Data analysis engine 225 may be configured to receive the data analytics request and parse the data analytics request to determine the selected data filters or other attributes. Data analysis engine 225 may query data storage 220 to retrieve the stored data based on the parsed data filters in data analytics request. Method 601 may comprise generating a data output (step 606). Data analysis engine 225 may generate data output 190 to comprise all of the data retrieved during step 604. Method 601 may comprise transmitting the data output (step 608). Data analysis engine 225 may transmit the data output 190 to data output interface 280 for transmission or display to user terminal 295, as previously discussed.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “transmit” may include sending electronic data from one system component to another over a network connection. Additionally, as used herein, “data” may include encompassing information such as commands, queries, files, data for storage, and the like in digital or any other form.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between data elements. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

As used herein, “electronic communication” may comprise a physical coupling and/or non-physical coupling capable of enabling components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection.

One or more of the components discussed herein may be in electronic communication via a network. As used herein, the term “network” may further include any cloud, cloud computing system, or electronic communications system or method that incorporates hardware and/or software components. Communication amongst the nodes may be accomplished through any suitable communication channels, such as, for example, a telephone network, an extranet, an intranet, Internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Internetwork Packet Exchange (IPX), APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the Internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, DSL, or various wireless communication methods. It is noted that the network may be implemented as other types of networks, such as an interactive television (ITV) network. Moreover, the system contemplates the use, sale or distribution of any goods, services or information over any network having similar functionality described herein.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.), a uniform resource locator (“URL”), a document (e.g., a MICROSOFT® Word™ document, a MICROSOFT® Excel® document, an ADOBE® .pdf document, etc.), an “ebook,” an “emagazine,” an application or microapplication (as described herein), an SMS or other type of text message, an email, a FACEBOOK® message, a TWITTER® tweet, MMS and/or other type of communication technology. In various embodiments, a channel may be hosted or provided by a data partner. In various embodiments, the distribution channel may include at least one of a social media site, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of mobile device communications include texting, email, and mobile applications for smartphones.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. As those skilled in the art will appreciate, user computer may include an operating system (e.g., WINDOWS®, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random-access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

The terms “computer program medium” and “computer usable medium” and “computer readable medium” are used to generally refer to media such as removable storage drive and a hard disk installed in hard disk drive. These computer program products provide software to computer system.

The computer system may also include a communications interface. Communications interface allows software and data to be transferred between computer system and external devices. Examples of communications interface may include a modem, a network interface (such as an Ethernet card), a communications port, etc. Software and data files transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, software may be stored in a computer program product and loaded into a computer system using removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware state machine so as to perform the functions described herein will be apparent to persons skilled in the relevant art(s).

In various embodiments, components, modules, and/or engines described herein may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

In various embodiments, the system may implement middleware to provide software applications and services, and/or to bridge software components in the computer based system, such as the operating system, database, applications, and the like. Middleware may include any hardware and/or software suitably configured to facilitate communications and/or process communications between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process communications between the various components of an application server and any number of internal or external systems for any of the purposes disclosed herein. WEB SPHERE® MQ™ (formerly MQSeries) by IBM®, Inc. (Armonk, N.Y.) is an example of a commercially available middleware product. An Enterprise Service Bus (“ESB”) application is another example of middleware.

The systems, computers, computer based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art and are covered in many standard texts. As a further example, representational state transfer (REST), or RESTful, web services may provide one way of enabling interoperability between applications.

In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

In various embodiments, the server may include application servers (e.g. WEBSPHERE®, WEBLOGIC®, JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINTJX® or WINDOWS® operating systems, etc.).

Users, systems, computer based systems, or the like may communicate with the server via a web client. The web client includes any device or software which communicates via any network, such as, for example any device or software discussed herein. The web client may include internet browsing software installed within a computing unit or system to conduct communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE® CHROME® software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

Any database, data structure, or the like discussed herein may include relational, hierarchical, graphical, blockchain, object-oriented structure, and/or any other database configurations. Any database, data structure, or the like may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

In various embodiments, the system may also contemplate uses with AMAZON® Simple Storage Service (S3), AMAZON® DynamoDB (and/or any other suitable NoSQL database service), AMAZON® Relational Database Service (RDS), and/or any other suitable web service, database service, or the like.

The blockchain structure may include a distributed database that maintains a growing list of data records. The blockchain may provide enhanced security because each block may hold individual transactions and the results of any blockchain executables. Each block may contain a timestamp and a link to a previous block. Blocks may be linked because each block may include the hash of the prior block in the blockchain. The linked blocks form a chain, with only one successor block allowed to link to one other predecessor block. Forks may be possible where divergent chains are established from a previously uniform blockchain, though typically only one of the divergent chains will be maintained as the consensus chain.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data, in the database or associated with system, by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may also be annotated in a standard manner. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers, or other components of the system may consist of any combination thereof at a single location or at multiple locations, wherein each database, system, device, server, and/or other component includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPT”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server, any other application server components or may reside within another computing device or may take the form of a standalone hardware component.

The systems and methods may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like. Cryptography and network security methods are well known in the art and are covered in many standard texts.

In various embodiments, the software elements described herein may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, SONY BLU-RAY DISC®, optical storage devices, magnetic storage devices, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for ingesting and processing data in a data processing environment, comprising:
a processor; and
a tangible, non-transitory memory configured to communicate with the processor, the tangible, non-transitory memory having instructions stored thereon that, in response to execution by the processor, cause the processor to perform operations comprising:
receiving, by the processor, data inputs from a plurality of data sources, wherein at least one of the data sources comprises a behavioral monitoring application;
parsing, by the processor, the data inputs to determine data contained within each data input; and
transmitting, by the processor, the data inputs to a data storage, wherein the data inputs are stored based on the parsed data contained within each data input.

2. The system of claim 1, wherein the behavioral monitoring application is configured to monitor at least one of a user device or mobile applications installed on the user device.

3. The system of claim 2, wherein the behavioral monitoring application is configured to return data inputs comprising at least one of user data, device information, network information, or mobile application data.

4. The system of claim 1, wherein the data inputs comprise at least one of demographic data, consumer likes or dislikes, consumer preferences, or consumer spending habits.

5. The system of claim 1, further comprising querying, by the processor, the data storage to determine whether the parsed data from the data inputs at least partially match stored data in the data storage.

6. The system of claim 5, wherein in response to determining that the parsed data from the data inputs at least partially match stored data, the data input is associated with the stored data prior to storing the data input.

7. The system of claim 1, further comprising:
receiving, by the processor, a data analytics query comprising a selected data filter;
retrieving, by the processor, the data input based on the selected data filter; and
generating, by the processor, a data output comprising the retrieved data input.

8. The system of claim 1, wherein at least one of the data sources comprise a data report or survey data.

9. The system of claim 1, wherein at least one of the data sources comprise United States Census Bureau data.

10. The system of claim 1, wherein at least one of the data sources comprise a shopping loyalty program.

11. A method of ingesting and processing data in a data processing environment, comprising:
receiving, by the data processing environment, data inputs from a plurality of data sources, wherein at least one of the data sources comprises a behavioral monitoring application;
parsing, by the data processing environment, the data inputs to determine data contained within each data input;
transmitting, by the data processing environment, the data inputs to a data storage, wherein the data inputs are stored based on the parsed data contained within each data input;
receiving, by the data processing environment, a data analytics query comprising a plurality of selected data filters;
retrieving, by the data processing environment, data inputs based on the selected data filters; and
generating, by the data processing environment, a data output comprising the retrieved data inputs.

11. The method of claim 10, wherein the behavioral monitoring application is configured to monitor at least one of a user device or mobile applications installed on the user device.

12. The method of claim 11, wherein the behavioral monitoring application is configured to return data inputs comprising at least one of user data, device information, network information, or mobile application data.

13. The method of claim 10, wherein the data inputs comprise at least one of demographic data, consumer likes or dislikes, consumer preferences, or consumer spending habits.

14. The method of claim 10, further comprising querying, by the data processing environment, the data storage to determine whether the data from the data inputs at least partially match stored data in the data storage.

15. The method of claim 14, wherein in response to determining that the data from the data inputs at least partially match stored data, the data input is associated with the stored data prior to storing the data input.

16. The method of claim 10, wherein the data sources comprise one of a data report, survey data, United States Census Bureau data, or a shopping loyalty program.

17. An article of manufacture including a non-transitory, tangible computer readable storage medium having instructions stored thereon that, in response to execution by a computer based system, cause the computer based system to perform operations comprising:
receiving, by the computer based system, data inputs from a plurality of data sources, wherein at least one of the data sources comprises a behavioral monitoring application;
parsing, by the computer based system, the data inputs to determine data contained within each data input;
transmitting, by the computer based system, the data inputs to a data storage, wherein the data inputs are stored based on the parsed data contained within each data input;
receiving, by the computer based system, a data analytics query comprising a plurality of selected data filters;
retrieving, by the computer based system, data inputs based on the selected data filters; and
generating, by the computer based system, a data output comprising the retrieved data inputs.

18. The article of manufacture of claim 17, wherein the behavioral monitoring application is configured to monitor at least one of a user device or mobile applications installed on the user device, and wherein the behavioral monitoring application is configured to return data inputs comprising at least one of user data, device information, network information, or mobile application data.

19. The article of manufacture of claim 17, wherein the data inputs comprise at least one of demographic data, consumer likes or dislikes, consumer preferences, or consumer spending habits.

20. The article of manufacture of claim 17, wherein the data sources comprise one of a data report, survey data, United States Census Bureau data, or a shopping loyalty program.
